(19) United States
(12) Patent Application Publication
(10) Pub. No.: US 2022/0093001 A1
(43) Pub. Date: Mar. 24, 2022

(54) RELAYING OPTIMIZED STATE AND BEHAVIOR CONGRUENCE

(71) Applicant: International Business Machines Corporation, Armonk, NY (US)

(72) Inventors: Jennifer L. Szkatulski, Rochester, MI (US); Shikhar Kwatra, San Jose, CA (US); Erick Black, Franktown, CO (US); John E. Petri, St. Charles, MN (US)

(21) Appl. No.: 17/025,128

(22) Filed: Sep. 18, 2020

(51) Int. Cl. G09B 19/00; G06N 20/20

(52) U.S. Cl. CPC G09B 19/00; G06F 3/14; G06N 20/20

(57) ABSTRACT

Machine logic (for example, hardware, software) for determining when a human individual is presenting conflicting emotions, and presenting that information through an augmented reality (AR) system, such as by a visual text message displayed as an overlay display through AR goggles. Some embodiments also present information about how the situation with the human user, who is displaying the conflicting emotions, might be best handled by others interacting with that human individual. Some embodiments may use supervised and/or unsupervised machine learning (ML).

### BACKGROUND

The present invention relates generally to the field of sentiment analysis and also to the field of augmented reality (AR) devices.

The Wikipedia entry for “sentiment analysis” (as of 15 Mar. 2020) states, in part, as follows: “Sentiment analysis (also known as opinion mining or emotion AI) refers to the use of natural language processing, text analysis, computational linguistics, and biometrics to systematically identify, extract, quantify, and study affective states and subjective information. Sentiment analysis is widely applied to voice of the customer materials such as reviews and survey responses, online and social media, and healthcare materials for applications that range from marketing to customer service to clinical medicine . . . . A basic task in sentiment analysis is classifying the polarity of a given text at the document, sentence, or feature/aspect level—whether the expressed opinion in a document, a sentence or an entity feature/aspect is positive, negative, or neutral. Advanced, “beyond polarity” sentiment classification looks, for instance, at emotional states such as “angry”, “sad”, and “happy” . . . . Existing approaches to sentiment analysis can be grouped into three main categories: knowledge-based techniques, statistical methods, and hybrid approaches . . . . Open source software tools as well as range of free and paid sentiment analysis tools deploy machine learning, statistics, and natural language processing techniques to automate sentiment analysis on large collections of texts, including web pages, online news, internet discussion groups, online reviews, web blogs, and social media. Knowledge-based systems, on the other hand, make use of publicly available resources, to extract the semantic and affective information associated with natural language concepts. Sentiment analysis can also be performed on visual content, i.e., images and videos . . . ” (footnotes omitted)

The Wikipedia entry for “augmented reality” (as of 15 Mar. 2020) states, in part, as follows: “Augmented reality (AR) is an interactive experience of a real-world environment where the objects that reside in the real world are enhanced by computer-generated perceptual information, sometimes across multiple sensory modalities, including visual, auditory, haptic, somatosensory and olfactory. An augogram is a computer generated image that is used to create AR. Augography is the science and practice of making augograms for AR. AR can be defined as a system that fulfills three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. In this way, augmented reality alters one's ongoing perception of a real-world environment, whereas virtual reality completely replaces the user's real-world environment with a simulated one . . . . Augmented reality may have a positive impact on work collaboration as people may be inclined to interact more actively with their learning environment. It may also encourage tacit knowledge renewal which makes firms more competitive. AR was used to facilitate collaboration among distributed team members via conferences with local and virtual participants. AR tasks included brainstorming and discussion meetings utilizing common visualization via touch screen tables, interactive digital whiteboards, shared design spaces and distributed control rooms.” (footnotes omitted)

### SUMMARY

According to an aspect of the present invention, there is a method, computer program product and/or system that performs the following operations (not necessarily in the following order): (i) receiving a plurality of emotion cues being presented by a secondary user, with the emotion cues being based, at least in part, upon one, or more, of the following informational sources: the secondary user's facial expressions, the secondary user's body posture/movement and/or the secondary user's speech; (ii) determining, by machine logic, that the plurality of emotion cues indicate conflicting emotions of the secondary user; (iii) generating, by machine logic, a conflicting emotions message including natural language text that indicates the conflicting emotions; and (iv) sending the conflicting emotions message for presentation by the AR subsystem, in human understandable form and format, to the primary user.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a screenshot view, displayed on AR goggles, generated by the first embodiment system.

### DETAILED DESCRIPTION

Some embodiments are directed to machine logic (for example, hardware, software) for determining when a human individual is presenting conflicting emotions, and presenting that information through an augmented reality (AR) system, such as by a visual text message displayed as an overlay display through AR goggles. Some embodiments also present information about how the situation with the human user, who is displaying the conflicting emotions, might be best handled by others interacting with that human individual. This Detailed Description section is divided into the following subsections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

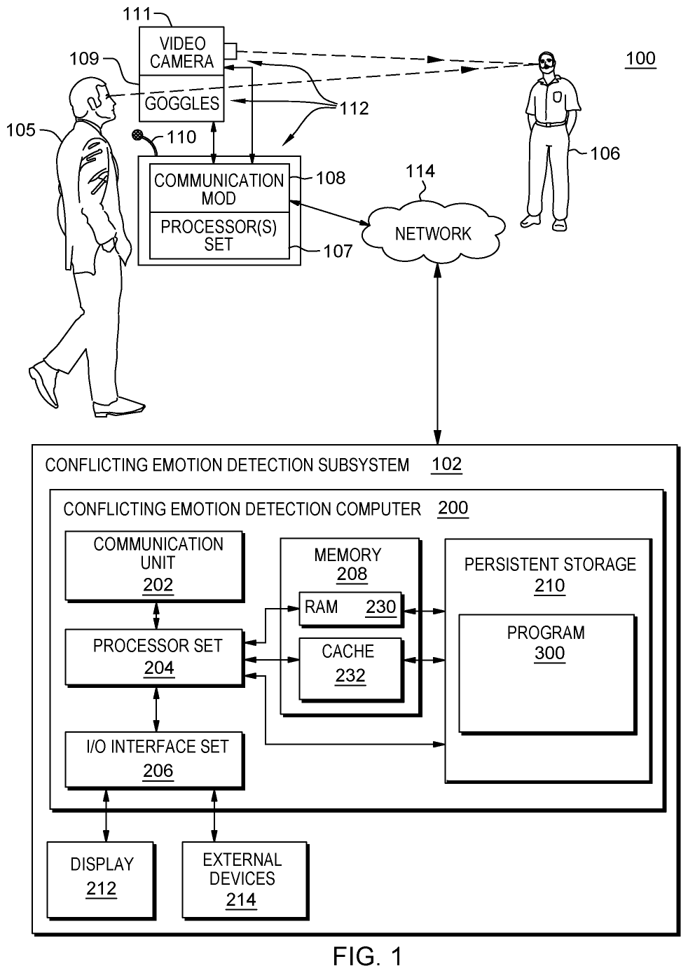

As shown in FIG. 1, networked computers system 100 is an embodiment of a hardware and software environment for use with various embodiments of the present invention. Networked computers system 100 includes: conflicting emotion detection subsystem 102 (sometimes herein referred to, more simply, as subsystem 102); primary user 105; secondary user 106; AR subsystem 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

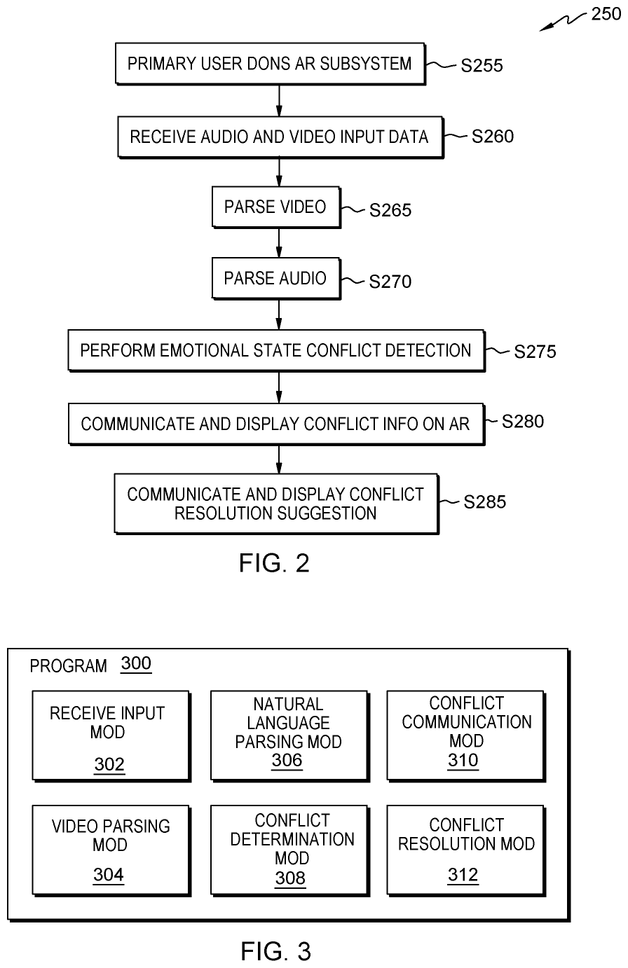

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where primary user 105 dons AR subsystem 112 (including processor(s) set 107, communication module (“mod”) 108, AR (augmented reality) goggles 109, microphone 110 and video camera 111). In this example, primary user 105 directs his/her attention to secondary user 106, which means that: (i) video camera 111 captures video information that shows the facial expressions and body movements/positions of secondary user 106; and (ii) microphone 110 records the words spoken by secondary user 106.

Processing proceeds to operation S260, where receive input data mod mod 302 of program 300 of conflicting emotion detection sub-system 102 receives: (i) a video data set of the video images of secondary user 106 from video camera 111 through communication mod 108 and communication network 114; and (ii) an audio data set of audio of the words spoken by secondary user 106 from microphone 110 through communication mod 108 and communication network 114.

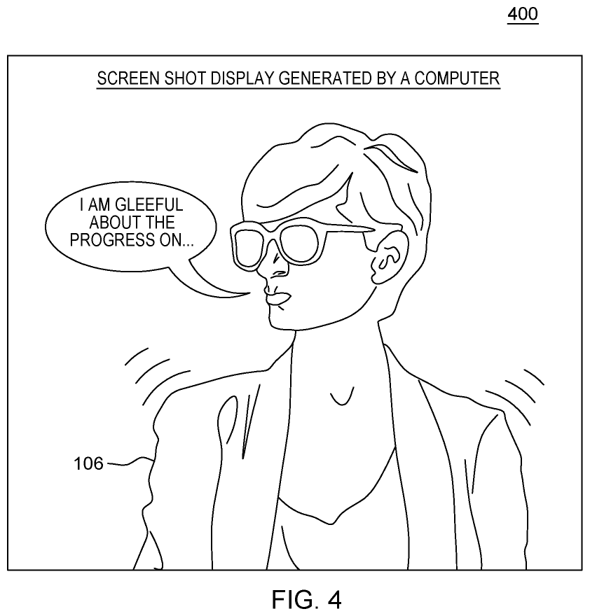

Processing proceeds to operation S265 where video parsing mod 304 parses the video data set to determine by its machine logic: (i) an emotional state of secondary user 106 most strongly indicated by the facial expressions of secondary user 106, which will herein be called the facial emotional state; and (ii) an emotional state of secondary user 106 most strongly indicated by the body movements and positions of secondary user 106, which will herein be called the body emotional state. In this example, the determined facial emotional state is “nervousness” because the secondary user's lips are pursed (see screen shot 400 of FIG. 4). In this example, the determined body emotional state is “fear” because the secondary user's shoulders are trembling (see screen shot 400 of FIG. 4).

Processing proceeds to operation S270, where natural language parsing mod 306 parses the audio data set to determine, by its machine logic, an emotional state of secondary user 106 most strongly indicated by the words spoken by secondary user 106, which will herein be called the verbal emotional state. In this example, the determined verbal emotional state is “glee” because the secondary user has just said: “I am gleeful about the progress on the new project.” (see screen shot 400 of FIG. 4).

Processing proceeds to operation S275, where conflict determination mod 308 determines, by its machine logic that: (i) the facial emotional state (nervousness) and the body emotional state (fear) are compatible emotional states and give rise to no apparent emotional conflict; (ii) the verbal emotional state (gleeful) conflicts with the facial emotional state (nervousness); and (iii) the verbal emotional state (gleeful) conflicts with the body emotional state (fear).

Processing proceeds to operation S280, where conflict communication mod 310 outputs an AR overlay emotion conflict message to AR subsystem 106 for display on AR goggles 109. This AR overlay emotion conflict message is presented in human understandable form and format in underlined text as shown in screen shot 400 of FIG. 4.

Processing proceeds to operation S285, where conflict resolution mod 312 outputs an AR overlay resolution message to AR subsystem 106 for display on AR goggles 109. This AR overlay resolution message is presented in human understandable form and format in double underlined text as shown in screen shot 400 of FIG. 4. As will be further discussed in the following sub-section of this Detailed Description section, the conflict resolution message (for example, video overlay message, audio message) give a recommendation to the primary user about how to deal with (or, in some situations, not deal with) the apparently conflicting emotional cues being presented by the secondary user.

### III. FURTHER COMMENTS AND/OR EMBODIMENTS

Some embodiments of the present invention recognize the following facts, potential problems and/or potential areas for improvement with respect to the current state of the art: (i) for many individuals, relaying and understanding traditional human emotion in patterns that are universally recognizable is an obstacle that is not easily surmounted; (ii) many have difficulty in navigating social environments in an optimal manner; (iii) colloquialisms, sarcasm, humor, veiled emotion, and changes in emotional states can be difficult to detect and can often lead to a breakdown in communication, causing frustration; (iv) an example of a facial expression that can cause confusion in social situations is a smile (which typically indicates a happy emotional state) through gritted teeth (which indicates an unhappy emotional state); (v) there are systems that can capture the variable states/contextual situations of different users in the vicinity and provide context to a primary user (who desires to best understand the emotional states of other individuals (sometimes referred to herein as “secondary users”)); and/or (vi) currently conventional technology lacks the ability to correlate the primary user's reactions to different contextual situations based on providing partial/different information relayed to the user and optimize the interaction guidance using feedback learning.

Some embodiments of the present invention may include one, or more, of the following operations, features, characteristics and/or advantages: (i) a system and method to relay optimized state and behavior congruence via an iterative learning mechanism; (ii) captures emotional and psychological state of a subject; (iii) relays that information back to a user to provide interaction guidance using iterative learning by monitoring user's reactions to different contextual situations and optimizing the output via feedback learning mechanism; and/or (iv) learns behavior on an individual level using supervised machine learning, as well as unsupervised machine learning.

Some embodiments of the present invention may include one, or more, of the following operations, features, characteristics and/or advantages: (i) developing a unique ensemble learning model by ingesting the Naïve-Bayes classifier and LSTM (Long short-term memory) output to the Semi-supervised RL (reinforcement learning) model; (ii) optimizes satisfaction rate in AR (augmented reality) display device; (iii) correlates the pattern history and user profile of plurality of users in a confined environment using one-to-one and one-to-many profile attributes analysis via reinforcement learning model infused with KNN (k nearest neighbors algorithm) for generating ameliorative output; and/or (iv) ameliorative output generation involves optimizing the communication by relaying relevant information combining the contextual pieces to maximize the satisfaction rate (reward function).

Some embodiments of the present invention may include one, or more, of the following operations, features, characteristics and/or advantages: (i) extremely useful for understanding workforce behavior and assisting primary users with understanding of the behaviors, expressions and/or word of other (that is, secondary users); (ii) extremely useful for understanding assisting primary users with better interpretation when faced with adverse situations while interaction in different environments; and/or (iii) uses Virtual Reality (VR) and/or Augmented Reality (AR).

Operation of an embodiment of the invention will now be discussed in the following five (5) paragraphs.

To determine a baseline, the system performs the following operations: (i) initiating the monitoring of user in different situations; (ii) storing a partial featured labelled set of user's metadata in the COS (Cloud Object Storage) containing user's characteristics as follows: (a) user's emotional states array[ ]={E1-En}, (b) users profile Array [ ]—Age, Emotional Empathy Code: {1, 2, None, etc.}, and (c) user defined attributes* [ ]; and (iii) determining sentiment analysis, tone—artificial intelligence classification running in AR device using the assist processor embedded in the device. In this embodiment, operation (iii) includes the following sub-operations: (a) sarcasm, humor understanding via LSTM-CNN (convolutional neural network) model, (b) Natural Language analysis using LDA (Latent Dirichlet Allocation) and skip-gram via word2vec is infused for gathering additional context and previous content information including the following sub-sub operations: (1) Word analysis—word2vec algorithm is inculcated in order to perform n-gram sentence segmentation for context understanding, (2) Naïve-Bayes classification algorithm to determine true sentiment as opposed to speech/word output (for example, a subject uses sarcasm in a joke when the opposite meaning of the words is actually meant—the user is notified that the subject is using sarcasm and can relay what the true meaning of the joke is, prompting with a suggested response (for example, polite laughter), and (3) Visual recognition—facial expression and body language interpretation. Sub-sub-operation (3) is performed via the following sub-sub-sub operations: (A) LSTM-CNN model taking into account a given user U's previous states and facial expressions corresponding to topical context, (B) video information is divided into chunks of image files in real-time to extract the states as they change over time sequence in order to decipher the user's emotional state and context, and (C) emotion learning mechanism (wearable data/biometrics for additional information gathering), including KNN classification of detected user behavior in context of situation and cluster user's emotion in one state S1 versus the other from a subset of {S1 Sn} in a given context C from a set of various defined contexts C={C1, C2 . . . Cn}.

To perform one-to-one/many mapping to monitor a user in view to gather their emotional state E and cognitive heuristics in a given context C, the system performs the following operations using an an emotion correlation and display mechanism: (i) visual display on person to visually represent their personal psychological state, and (ii) use Pearson Correlation to correlate the associative attributes with the user wearing the smart device for determine positive or negative association based on extrapolating the emotional states of both the users.

An emotion reception mechanism allows recipient of subject analysis to understand analyzed psychological state and intent using the following expedients: (i) AR glasses/mixed reality display; and (ii) mobile app using camera and microphone, tied to an analytic backend.

An emotion translator learns “deficiencies” in communication and highlights when environment, context, and content align with scenarios where deficiencies might occur. A library of responses and actions dictates prompted response.

As the final step of ensemble learning the stack of LSTM-CNN module, Naïve-Bayes classification output and Pearson Correlation output are used as environment E′ variables over a time sequence in different states for a given agent. The user's U action when interacting with a different set of users {U1, U2 . . . Un} at simultaneous or different time intervals is monitored using above context information analysis and user's reactions R from a set of reactions is studied in order to assess the reward function. If the user's satisfaction rate determined by cameras and AR glasses monitoring user's behavior is positive, an incremental reward function R-->+x is assigned to said user, otherwise, a reward R-->−x is assigned in which case, the system monitors the user's reactions and other user's behavior in a given context to optimize the policy associated with satisfaction rating maximization.

Some embodiments of the present invention include an emotion learning mechanism based on the six (6) basic human emotions: (a) happiness (for example, facial expressions such as smiling, body language such as a relaxed stance, an upbeat, pleasant tone of voice), (b) sadness (for example, dampened mood, quietness, lethargy, withdrawal from others, crying); (c) fear (for example, facial expressions such as widening the eyes and pulling back the chin, attempts to hide or flea from the threat, physiological reactions such as rapid breathing and heartbeat); (d) disgust (for example, turning away from the object of disgust, physical reactions such as reverse peristalsis, facial expressions such as wrinkling the nose and curling the upper lip; (e) anger (for example, facial expressions such as frowning or glaring, body language such as taking a strong stance or turning away from someone, tone of voice such as speaking gruffly or yelling, physiological responses such as sweating or turning red, aggressive behaviors, and (f) surprise (for example, facial expressions such as raising the brows, widening the eyes, opening the mouth, physical responses such as jumping back, verbal reactions such as yelling, screaming, or gasping. Some embodiments use sensors, cameras, microphone, and other related devices to determine a subject's current state. This emotion learning mechanism is used by the system to learn biometrics, behaviors, and “body language” for each given state. Nuance in intensity of emotion is also recorded. For example, a subject wears relevant sensors throughout the day and clicks a button and records his psychological state when he is feeling one of the six (6) basic emotions. Intensity can also be recorded. This information is analyzed and correlated to additional sensor data to capture the behavior and characteristics of the individual's emotional baseline and variance from baseline state.

Some embodiments of the present invention include an emotion motion reception mechanism. Based on what the emotion learning mechanism has learned, a user is provided with an interpretation of what he or she is seeing or experiencing. For example, if a primary user is using our system and is speaking with a secondary user who is happy, then the primary user can “see” that clearly via a visual display either through AR/mixed reality glasses that she wears or via an app on his mobile device. If the secondary user's speech and tone do not match her other behavioral characteristics, it may be interpreted as sarcasm or humor and the primary user is notified of such and prompted with proper responses. This eliminates the need to fully understand nuance and sarcasm which can be difficult to notice, appreciate and/or understand. In addition, social cues can be provided via augmented reality or sensory feedback. As a further example, if primary user is engaging with someone who is angry, the subject can clearly “see” that he or she is angry and can be prompted with ideas on how to reduce the secondary user's anger. For example, the prompt may be worded as follows: “Tell the secondary user that you believe that they have become frustrated and ask the secondary user what has caused the apparent frustration.”

Some embodiments of the present invention are adapted for Parent/Child Interaction. Parent/Child conflict is often a result of mis-interpreted emotions and actions. A young child may “act out” due to being upset, uncomfortable, or simply hungry. A teenager may appear to be angry and rebellious, however they may just be heart-broken. Parents' reactions to the child may exacerbate the problem which can lead to further relational distance. The opposite is also true. A parent may appear to be angry or ambivalent toward their child, when the reality is the activities of the day have taken a toll on them. By having a baseline for each of these individuals each would know that reaction of the other was out of the ordinary and that understanding, separation and time may be necessary to help diffuse the situation. This baseline can also show if real change is occurring that might require additional support to work out.

Some embodiments of the present invention may include one, or more, of the following operations, features, characteristics and/or advantages: (i) allows for individualized learned behavior or prompting of next steps as a reward strategy in case the user seems confused with the interpretation; (ii) model includes a variable output generation based on time sequence in order to keep refining the satisfaction rate of the user with learnt correlation; (iii) interprets and translates behavior and psychological state for interaction with another user; (iv) incorporates learned subject behavior; (v) uses the same machine learning mechanisms to determine true psychological state; (vi) incorporates behavior (using visual recognition), and tailoring it to an individual to detect things such as sarcasm and humor; (vii) a mechanism of inspecting both surrounding context (can be a user/sender talking) and a primary user's reactions to the contextual situations in order to reinforce the mechanism for provision of relevant information (overlay in AR for instance); and/or (viii) optimizes the comfort level for the recipient through iterative feedback.

A method, according to an embodiment of the present invention, for iteratively communicating a cognitive state of a first person to a second person includes the following operations (not necessarily in the following order): (i) receiving information related to the first person interacting with the second person and wherein the information includes audio, textual, video, and images; (ii) utilizing an artificial intelligence (AI) and/or machine learning (ML) trained model to iteratively assess a cognitive state of the first person; and (iii) indicating the iteratively assessed emotional state of the first person to the second person. In some embodiments, the indication of emotional state is tailored to characteristics of the second person and adjusted based on an optimization (for example, reward) feedback mechanism. In some embodiments, the AI model is an ensemble learning model ingesting an Naïve-Bayes classifier and LSTM output to the Semi-supervised RL model for optimization of satisfaction rate in an AR display device. In some embodiments, the first person uses sarcasm in a joke when an opposite meaning of the words is actually meant and the second person is notified that the first person is using sarcasm and an indication of a true meaning of the joke and a suggested response (for example, polite laughter). In some embodiments, the cognitive state includes an emotive state in conjunction with multitude of thought processes and/or a specific state of mind at a temporal period.

Some embodiments of the present invention may include one, or more, of the following operations, features, characteristics and/or advantages: (i) leverages cognitive state over time series pattern after a response/discomfort has been monitored in order to relay that information back to a user to provide interaction guidance using iterative learning; (ii) monitors a user's reactions to different contextual situations and optimizing the output via feedback learning mechanism; (iii) the system learns “deficiencies” in communication and highlights when environment, context, and content align with scenarios where deficiencies might occur; (iv) a library of responses and actions. dictates prompted response; (v) inspecting both surrounding context (can be a user/sender talking) and a primary user's reactions to said contextual situations in order to reinforce the mechanism for provision of relevant information (overlay in AR for instance), thereby optimizing the comfort level for the recipient through iterative feedback; (vi) learns behavior on an individual level using supervised machine learning, as well as unsupervised machine learning; (vii) involves developing a unique ensemble learning model by ingesting the Naïve-Bayes classifier and LSTM output to the Semi-supervised RL model for optimization of satisfaction rate in AR display device; (viii) correlates the pattern history and user profile of plurality of users in a confined environment using one-to-one and one-to-many profile attributes analysis via reinforcement learning model infused with KNN for generating ameliorative output; and/or (ix) the ameliorative output generation involves optimizing the communication by relaying relevant information combining the contextual pieces to maximize the satisfaction rate (reward function).

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM), for use by a primary user equipped with an augmented reality (AR) system, the CIM comprising:
receiving a plurality of emotion cues being presented by a secondary user, with the emotion cues being based, at least in part, upon one, or more, of the following informational sources: the secondary user's facial expressions, the secondary user's body posture/movement and/or the secondary user's speech;
determining, by machine logic, that the plurality of emotion cues indicate conflicting emotions of the secondary user;
generating, by machine logic, a conflicting emotions message including natural language text that indicates the conflicting emotions; and
sending the conflicting emotions message for presentation by the AR subsystem, in human understandable form and format, to the primary user.

2. The CIM of claim 1 further comprising:
presenting the conflicting emotions message to the primary user as visual overlay text presented in AR goggles included in the AR system.

3. The CIM of claim 1 wherein:
the determination that the plurality of emotion cues indicate conflicting emotions is performed, at least in part, by machine logic of the AR subsystem; and
the generation of the conflicting emotions message is performed, at least in part, by machine logic of the AR subsystem.

4. The CIM of claim 1 wherein:
the determination that the plurality of emotion cues indicate conflicting emotions is performed, at least in part, by machine logic in a set of computer(s) that is remote from the AR subsystem and which communicates with the AR subsystem over a communication network; and
the generation of the conflicting emotions message is performed, at least in part, by machine logic in a set of computer(s) that is remote from the AR subsystem and which communicates with the AR subsystem over a communication network.

5. The CIM of claim 1 further comprising:
capturing, by a camera included in the AR system, a video data set including video information indicative of facial expression(s) of the secondary user; and
parsing, by machine logic, the video information to determine at least one emotional cue of the plurality of emotional cues that is based upon facial expression of the secondary user.

6. The CIM of claim 1 further comprising:
capturing, by a camera included in the AR system, a video data set including video information indicative of body posture(s)/movement(s) of the secondary user; and
parsing, by machine logic, the video information to determine at least one emotional cue of the plurality of emotional cues that is based upon body posture/movement of the secondary user.

7. The CIM of claim 1 further comprising:
capturing, by a camera included in the AR system, an audio data set including audio information indicative of speech of the secondary user; and
parsing, by machine logic, the audio information to determine at least one emotional cue of the plurality of emotional cues that is based upon speech of the secondary user.

8. The CIM of claim 1 further comprising:
generating, by machine logic, a conflicting emotions resolution message including natural language text that indicates recommended action(s) that the primary user can take to resolve the conflicting emotions of the secondary user; and
sending the conflicting emotions resolution message for presentation by the AR subsystem, in human understandable form and format, to the primary user.

9. The CIM of claim 8 further comprising:
presenting the conflicting emotions resolution message to the primary user as visual overlay text presented in AR goggles included in the AR system.

10. The CIM of claim 1 wherein the conflicting emotions of the secondary users are a behavior incongruence.

11. The CIM of claim 1 further comprising:
using iterative learning by:
monitoring the primary user's reactions to different contextual situations; and
optimizing an output information stream by a feedback learning mechanism.

12. The CIM of claim 1 further comprising:
learning behavior on an individual level at least by supervised machine learning.

13. The CIM of claim 1 further comprising:
learning behavior on an individual level at least by unsupervised machine learning.

14. The CIM of claim 1 further comprising:
learning behavior on an individual level by a combination of both supervised and unsupervised machine learning.

15. The CIM of claim 1 further comprising:
developing an ensemble learning model by ingesting a Naïve-Bayes classifier and LSTM (Long short-term memory) output to a semi-supervised RL (reinforcement learning) model.

16. The CIM of claim 8 wherein the generation of the conflicting emotions resolution message includes correlating a pattern history and user profile of a plurality of users in a confined environment using one-to-one and one-to-many profile attributes analysis via reinforcement learning model infused with KNN (k nearest neighbors algorithm).

17. The CIM of claim 8 wherein the generation of the conflicting emotions resolution message includes optimizing the conflicting emotions resolution message by relaying relevant information combining a plurality of contextual pieces to maximize a satisfaction rate using a reward function.

18. The CIM of claim 1 further comprising:
performing one-to-one/many mapping to monitor a user in view to gather their emotional state E and cognitive heuristics in a given context C performing the following sub-operations:
using an emotion correlation and display mechanism to obtain a visual display on the secondary user to visually represent the secondary user's affective state, and
using Pearson Correlation to correlate a plurality of associative attributes with the primary user to determine a positive or negative association based on extrapolating affective states of both of the primary and secondary users.

19. A computer program product (CPP), for use by a primary user equipped with an augmented reality (AR) system, the CPP comprising:
a set of storage device(s); and
computer code stored on the set of storage device(s), with the computer code including data and instructions for causing a processor(s) set to perform at least the following operations:
receiving a plurality of emotion cues being presented by a secondary user, with the emotion cues being based, at least in part, upon one, or more, of the following informational sources: the secondary user's facial expressions, the secondary user's body posture/movement and/or the secondary user's speech,
determining, by machine logic, that the plurality of emotion cues indicate conflicting emotions of the secondary user,
generating, by machine logic, a conflicting emotions message including natural language text that indicates the conflicting emotions, and
sending the conflicting emotions message for presentation by the AR subsystem, in human understandable form and format, to the primary user.

20. A computer system (CS), for use by a primary user equipped with an augmented reality (AR) system, the CS comprising:
a processor(s) set;
a set of storage device(s); and
computer code stored on the set of storage device(s), with the computer code including data and instructions for causing the processor(s) set to perform at least the following operations:
receiving a plurality of emotion cues being presented by a secondary user, with the emotion cues being based, at least in part, upon one, or more, of the following informational sources: the secondary user's facial expressions, the secondary user's body posture/movement and/or the secondary user's speech,
determining, by machine logic, that the plurality of emotion cues indicate conflicting emotions of the secondary user,
generating, by machine logic, a conflicting emotions message including natural language text that indicates the conflicting emotions, and
sending the conflicting emotions message for presentation by the AR subsystem, in human understandable form and format, to the primary user.
